(19) United States
(12) Patent Application Publication
(10) Pub. No.: US 2017/0100740 A1
(43) Pub. Date: Apr. 13, 2017

(54) COMPOUND APPLICATOR

(71) Applicant: Ingersoll Products Inc., Ingersoll (CA)

(72) Inventor: Jamie Pentland, London (CA)

(21) Appl. No.: 15/381,309

(22) Filed: Dec. 16, 2016

Related U.S. Application Data
(63) Continuation of application No. PCT/CA2015/050580, filed on Jun. 23, 2015.
(60) Provisional application No. 62/016,912, filed on Jun. 25, 2014.

(51) Int. Cl. B05C 17/10; E04F 21/165; B05C 17/01; B05C 5/02; B05C 17/005

(52) U.S. Cl. CPC B05C 17/10; B05C 5/0262; B05C 17/00516; B05C 17/0123; E04F 21/165

(57) ABSTRACT

A compound applicator includes: an applicator head which includes a body for applying a bead of compound onto a surface, wherein the profile of the compound bead has a convex profile with a crown and bead thickness; a device for controlling the crown and bead thickness of the convex profile with an adjustment mechanism. The adjustment mechanism includes a blade which includes a horizontal portion and a vertical portion and wherein the distal ends of the horizontal portion of the blade abut against the body, such that the blade can be resiliently flexed between a highest cambered position and a low camber position by vertically displacing a central portion of the blade.

The present application is a national stage entry of international application PCT/CA2015/050580 which claims priority from regularly filed U.S. provisional patent application 62/016,912 filed Jun. 25, 2014 under the title; COMPOUND APPLICATOR in the name of Jamie Pentland.

### FIELD OF THE INVENTION

The present concept relates to compound applicators and more particularly relates to applicator heads used in conjunction with compound applicators.

### BACKGROUND OF THE INVENTION

The compound applicator of the present design utilizes a molded applicator head which includes a smooth surface flow channel and a uni-body design.

The molded uni-body design allows for the elimination of the formation of sharp internal corners, crevasses and raised obstructions within the compound flow channel that can be found in other similar tools that have machined surfaces and use multiple components and fasteners within their construction. These formations are difficult to clean after use and compound that is left to harden in these areas can later come loose while the tool is in use and mar the desired smooth appearance of the bead of compound being applied to the wall surface.

The applicator body and all components that make up the applicator are constructed of molded engineering plastics that are light weight and that will not corrode when in contact with water or the caustic materials the applicator is used to apply. This construction method effectively eliminates the use of metals that are heavier and that will corrode even when protective coatings are employed, as described by Murray in U.S. 2005/0100386 A1 filed Sep. 10, 2004, under the title: Methods and Apparatus for Drywall Tools.

Additionally it is possible to use clear plastic to allow the user visibility of the compound within the applicator body, which in turn enhances the ability to control the flow of compound being applied to the target surface.

The applicator body includes a connector and socket that allows an applicator reservoir to be rotatable and fluidly mounted easily into the receiving socket and held firmly in place by the enclosing receiving socket geometry. This arrangement also allows the applicator reservoir to be detached easily from the applicator socket and then attached to another applicator of similar design without the need of tools or disassembly such as that described by Ruha et al in U.S. Pat. No. 6,604,881 B2 filed May 1, 2001, under the title: applicator head.

The socket communicates compound to a transversely oriented applicator flow channel that disperses the compound across the width of the applicator and against the target surface namely a drywall seam the compound is being applied to.

The applicator head includes a camber adjustment mechanism for controlling the thickness and contour of the compound bead applied to a wall.

Skid pads are incorporated into the applicator body beneath the forward most projections on each side. Other known applicators employ wheels in this area that limits the movement of the tool to a linear path when being used. The employment of skid pads allows for the unrestricted movement of the applicator while in use, allowing the user to negotiate turns without interrupting the flow of compound being applied to a wall joint such as the outside corner of an archway as described by: Williams et al in US2809513 10/1957 filed Aug. 17, 1953 under the title Paint Applicator, and Ovens in US20100196078A1 filed Jan. 30, 2009 under the title Applicator for Applying Material Such as Mastic to a Surface.

### SUMMARY OF THE INVENTION

The present concept is an applicator for applying dry wall compound or other semi-fluid materials in a controlled manner to a flat surface joint, or to an outside wall joint or, in another embodiment, two surfaces that join at an inside corner.

The applicator includes a molded base head with an integrated receiving socket that allows for the flow of compound through a flow channel contained within the applicator head and onto any desired surface such as a wall.

The applicator has a removable horizontal blade that is adjustably mounted for the manipulation and control of the flow of compound material that is being applied to the target surface.

The curvature of the blade is adjustably set by means of an interlocking slide mechanism which allows for the compound to be applied to the target surface in a controlled range of desired thicknesses as well as with the desired camber profile of the applied compound.

The blade has a series of projections along its length that shear through the pseudoplastic drywall compound, making it easier to apply in a controlled manner with a smooth surface free of voids or other flaws.

The attachment between the applicator head and the applicator reservoir allows for a range of single axis rotation between the head and reservoir, giving the user better control of the applicator while the semi-fluid material is being applied to the target surface.

A tubular reservoir carries the source material being applied to the wall joint in a manner that distributes the weight over its length, lending the tool better balance and making it easier to operate.

The attachment method is such that the applicator reservoir can be easily detached and reattached to the applicator head, or another applicator head without the use of tools to do so.

All the components that comprise the applicator are made of engineering plastics that suffer no ill effects such as corrosion when in contact with the compound or water.

The present concept is a compound applicator which includes;

a) an applicator head for applying a bead of compound onto a surface, wherein the profile of the compound bead has a convex profile having a crown and bead thickness;
b) a means for manually controlling the crown and thickness of the convex profile with an adjustment mechanism;
c) wherein the adjustment mechanism includes a blade which includes a horizontal portion and a vertical portion such that the horizontal portion can be flexed between a highest cambered position and a no camber position.

The present concept is a compound applicator comprises;

a) an applicator head which includes a body for applying a bead of compound onto a surface, wherein the profile of the compound bead has a convex profile with a crown and bead thickness;
b) a means for controlling the crown and bead thickness of the convex profile with an adjustment mechanism;
c) wherein the adjustment mechanism includes a blade which includes a horizontal portion and a vertical portion and wherein the distal ends of the horizontal portion of the blade abut against the body, such that the blade can be resiliently flexed between a highest cambered position and a low camber position by vertically displacing a central portion of the blade.

Preferably wherein the adjustment mechanism further includes a cam and a cam follower, such that urging the cam follower laterally in one direction lifts the central portion of the blade up to a the highest cambered position and urging the cam follower laterally in the opposite direction lowers the central portion of the blade down to a low camber position.

Preferably wherein the cam follower is a linear inclined cam follower.

Preferably wherein the adjustment mechanism further includes an upstanding selector connected to the cam follower for finger actuation of the cam follower in the lateral direction.

Preferably wherein the horizontal portion includes vertical slots and the body includes corresponding slideably engaging positioning fingers to prevent lateral movement of the blade.

Preferably further including laterally spaced indents releasably engaging with the selector for indexing the cam follower in the highest cambered position, the low camber position and intermediate camber positions.

Preferably wherein the distal ends of the horizontal portion includes trailing edge left and right skids integrally part of the blade, the skids providing a smooth sliding area when the body contacts the surface.

Preferably wherein the horizontal portion including evenly laterally spaced projections, the projections are elongated along a longitudinal orientation and serve to create even flow across a bottom side of the horizontal portion.

Preferably further including a pivoting connector for connecting a compound applicator reservoir to the body and channeling compound from the reservoir to the body, the connector includes a hollow longitudinal section attached to a hollow transverse section, the transverse section dimensioned to fit in a socket defined in the body, such that the connector pivoting between a down position and an up position.

Preferably wherein the connector includes a cylindrical transverse section dimensioned to fit in a cylindrical socket such that the connector pivots about a pivot axis.

Preferably wherein the longitudinal section includes a threaded collar inlet for connecting to the reservoir.

Preferably wherein the body includes removable front skids located at the distal ends of a front portion of the body, the skids providing a smooth sliding area when the body contacts the surface.

Preferably further includes an applicator gun for urging compound out of the applicator reservoir, through the body and out through a flow channel defined in the body for distributing compound along the entire length of the blade.

Preferably further includes an applicator gun for urging compound out of the applicator reservoir, through the connector and body and out through a flow channel defined in the body for distributing compound along the entire length of the blade.

### FIGURE DESCRIPTIONS

The present concept will now be described by way of example only with reference to the following drawings in which:

FIG. 1 is a schematic top perspective view of the present concept namely drywall compound applicator head shown as a component of a drywall compound applicator applying drywall compound over a taped drywall seam.

FIG. 2 is an exploded assembly perspective view of the present concept a drywall compound applicator head.

FIG. 3 is a schematic central cross sectional view of the present concept a drywall compound applicator head further showing the plunger mechanism extended nearly to its longest travel position and the applicator reservoir in the down position.

FIG. 4 is a schematic central cross sectional view of the present concept a drywall compound applicator head further showing the plunger mechanism extended nearly to its longest travel position and the applicator reservoir in up position.

FIG. 5 is a schematic central cross section of the body component of the present concept a drywall compound applicator head.

FIG. 6 is a schematic transverse cross sectional view of the applicator head showing outlet camber mechanism set to the highest cambered position which is the least flow restricting “6” position.

FIG. 7 is a schematic transverse cross sectional view of the drywall compound applicator head further showing camber adjustment mechanism set to a low camber position specifically to the highly flow restricting “1” position.

FIG. 8 is a schematic bottom perspective view of the blade component of the present concept a drywall applicator head further showing the bottom side of the blade with projections.

FIG. 9 is a schematic cross sectional view of the taped drywall seam post application of compound via the present concept a drywall compound applicator head.

FIG. 10 is a bottom schematic view of the body component of the present design a drywall applicator head.

FIG. 11 is an exploded assembly perspective schematic view of a further embodiment of the present concept a drywall compound applicator head.

### DETAILED DESCRIPTION OF THE PREFERRED EMBODIMENTS

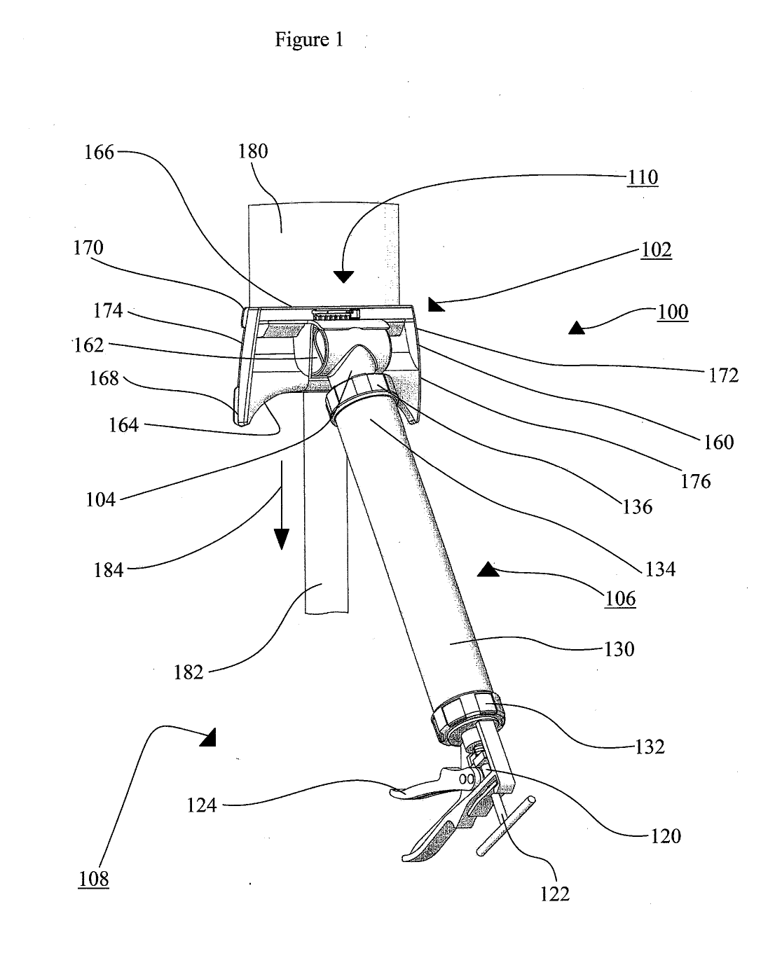

The present concept is a compound applicator shown generally as 100 as shown in FIG. 1. The major components of compound applicator 100 are as follows: applicator head 102 attached connector 104 which in turn is attached to applicator reservoir 106 which in turns is attached to applicator gun 108.

Applicator head 102 also includes an adjustment mechanism 110 which is described more fully below.

Applicator gun 108 of compound applicator 100 includes a ratchet mechanism 120 which includes a push rod 122 and a trigger 124. Ratchet mechanism 120 is of the type known in the art used in for example caulking guns.

Applicator reservoir 106 includes tube 130 which is attached to applicator gun 108 at cap 132 and is attached at outlet end 134 threadably to collar 136 of connector 104.

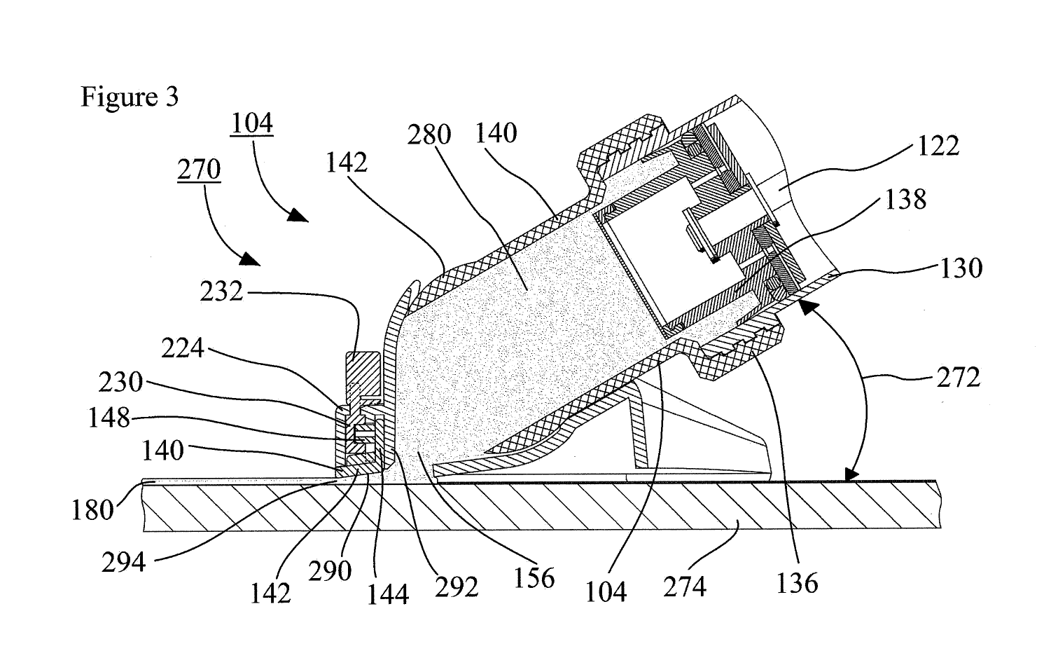

Tube 130 not shown in FIG. 1 however shown in FIG. 3 houses a piston 138 which is attached to push rod 122 and is urged longitudinally down through tube 130 for the purpose of urging compound or other materials found within tube 130 out through outlet end 134 of tube 130.

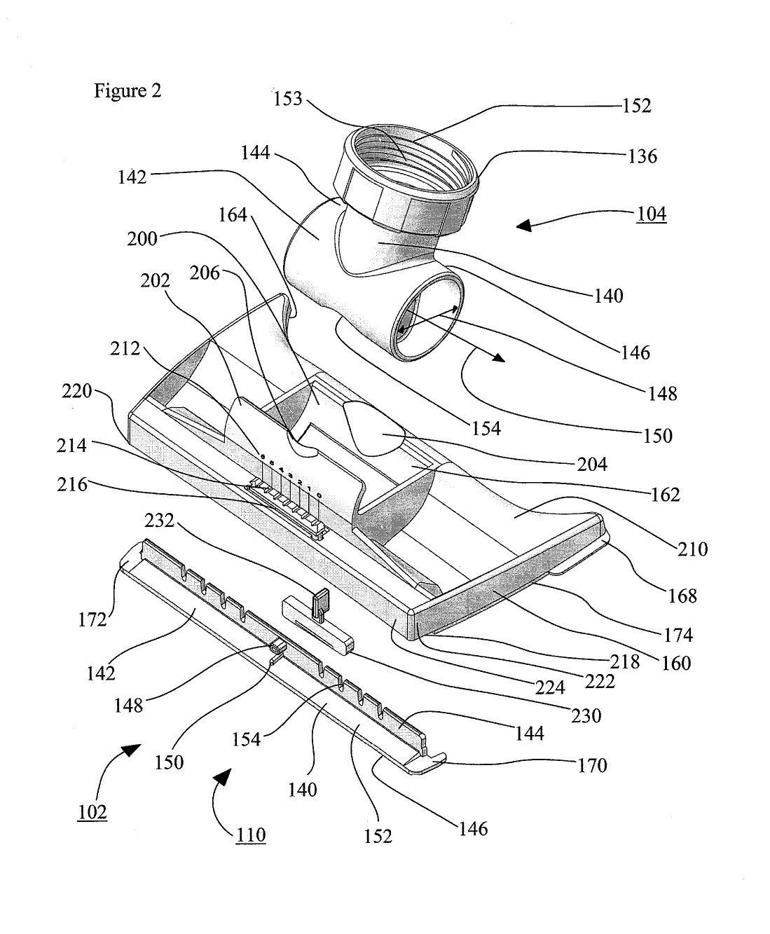

Connector 104 is connected to tube 130 via collar 136 which includes threads 152 which are shown in FIG. 2.

Referring now to FIG. 2 which shows further details of connector 104 which also includes a longitudinal section 140, a transverse section 142, a right shoulder 144 and a left shoulder 146. Transverse section 142 has a connector diameter 148 shown as D and pivots about pivot axis 150. Connector 104 further has an inlet 153 that communicates with the applicator reservoir 106 shown in FIG. 1; and an outlet 154 which communicates with flow channel 156 shown in FIG. 3.

Applicator head 102 has a body 160 which defines a socket 162 wherein the transverse section 142 of connector 104 snugly fits therein.

Applicator head 102 further includes leading edge 164, trailing edge 146, front skids 168, left skid 170, right skid 172, left edge 174 and right edge 176.

Further shown in FIG. 1 is compound bead 180 which is laid down by applicator head 102 overtop of tape 182 by moving the compound applicator 100 in the longitudinally downward direction 184 as show by the arrow in FIG. 1.

Referring now to FIG. 2 further details of the body 160 of applicator head 102 is shown.

Referring first of all to the socket 162 of applicator head 102 the reader will note that the transverse section 142 of connector 104 is a male cylindrically shaped element which is inserted into socket 162 which is also a cylindrically female shaped receptor.

Socket 162 includes bearing surfaces 200 socket flange 202, connector relief 204 and flange relief 206. Transverse section 142 slideably and pivotly is received onto bearing surface 200 of socket 162. Socket flange 202 is resiliently flexible enough such that one is able to simple insert the transverse section 142 of connector 104 by manually urging transverse section 142 downwardly into socket 162 until the transverse section 142 snaps in place.

Referring now to body 160 of applicator head 102 it further includes a front portion 210, a scale 212, indents 214, selector slot 216, a left abutment 218, a right abutment 220, a rear portion 222 and a rear wall 224.

Adjustment mechanism 110 includes a cam follower 230 which has a finger operated selector 232 attached thereto. Adjustment mechanism 110 further includes a blade 140 which includes a horizontal portion 142 and a vertical portion 144. Blade 140 further includes a trailing edge 146, a cam 148 and a tab 150.

Horizontal portion 142 has a top side 152 and vertical portion 144 includes vertical slots 154.

Referring now to FIG. 3 a portion of compound applicator 100 is shown in cross sectional view namely the applicator head together with a portion of the applicator reservoir 106 showing piston 138 therein as well as connector 104.

FIG. 3 shows a portion of tube 130 of applicator reservoir 106 in a down position 270 which has a tilt angle theta 272 of approximately 30° relative to the drywall 274.

FIG. 3 also shows the compound 280 which is forceably urged by piston 138 out through flow channel 156 and past retaining wall 292 and under the horizontal portion 142 of blade 140 which is at a slight incline 290 to the drywall 274 as shown in FIG. 3.

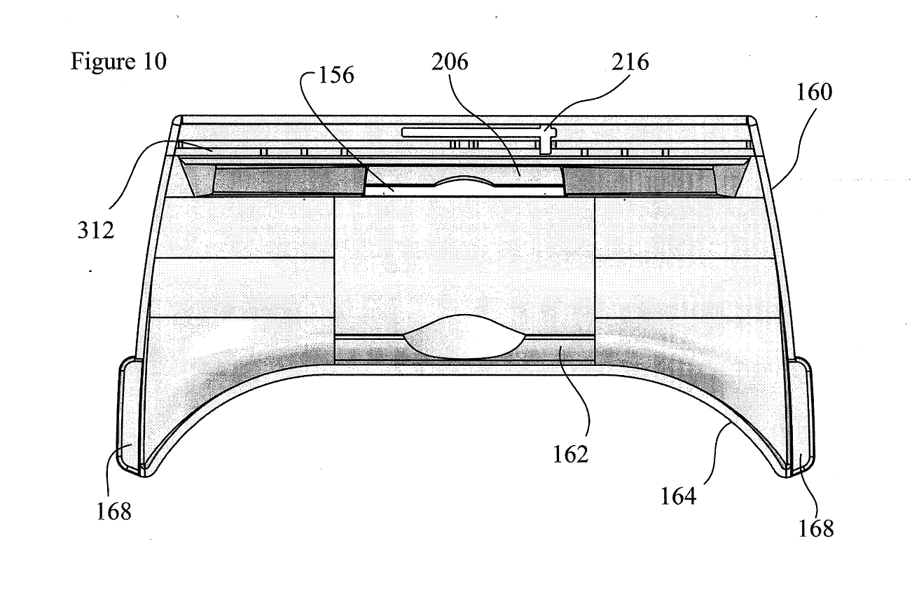

FIG. 10 shows the flow channel 156 in the body 160 without the blade 140. Compound 280 is urged through the flow channel 156 and laterally before passing under the horizontal portion 142 of the blade.

Eventually compound 280 is forceably urged out of exit slot 294 forming compound bead 180 on drywall 274.

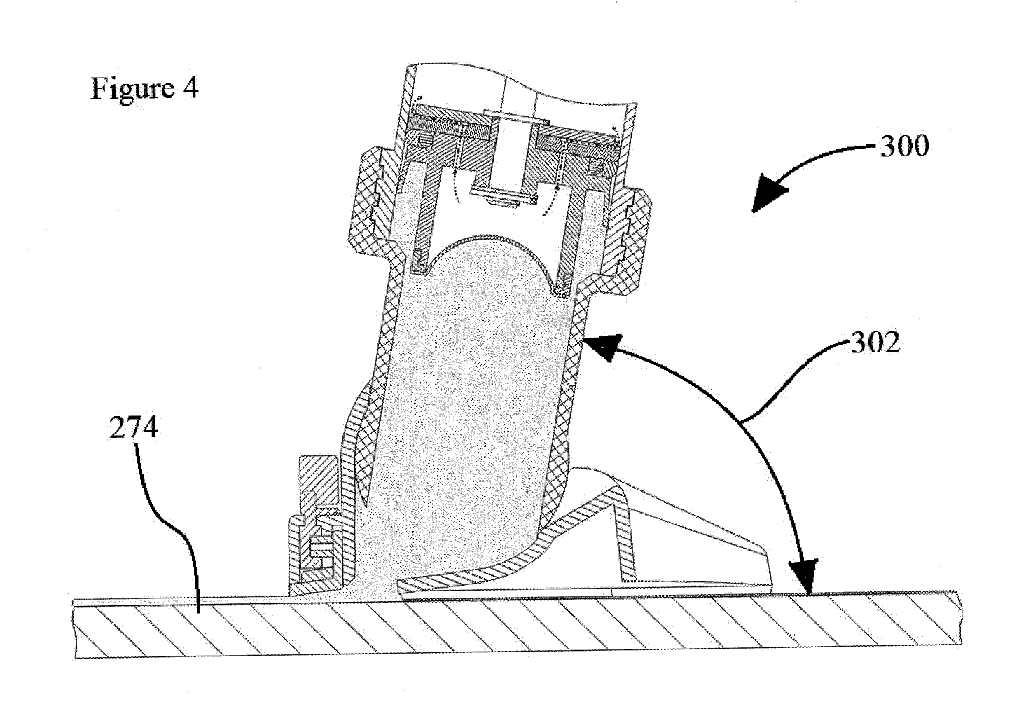

Referring now to FIG. 4 compound applicator 100 is shown in the maximum up position 300 wherein tilt angle theta shown as 302 is approximately 80°.

Therefore the tube 130 of applicator reservoir 106 can be tilted about pivot axis 150 from an angle of approximately 30° or relative to the drywall as shown in FIG. 3 to a maximum angle of approximately 80° relative to the drywall 274 as shown in FIG. 4.

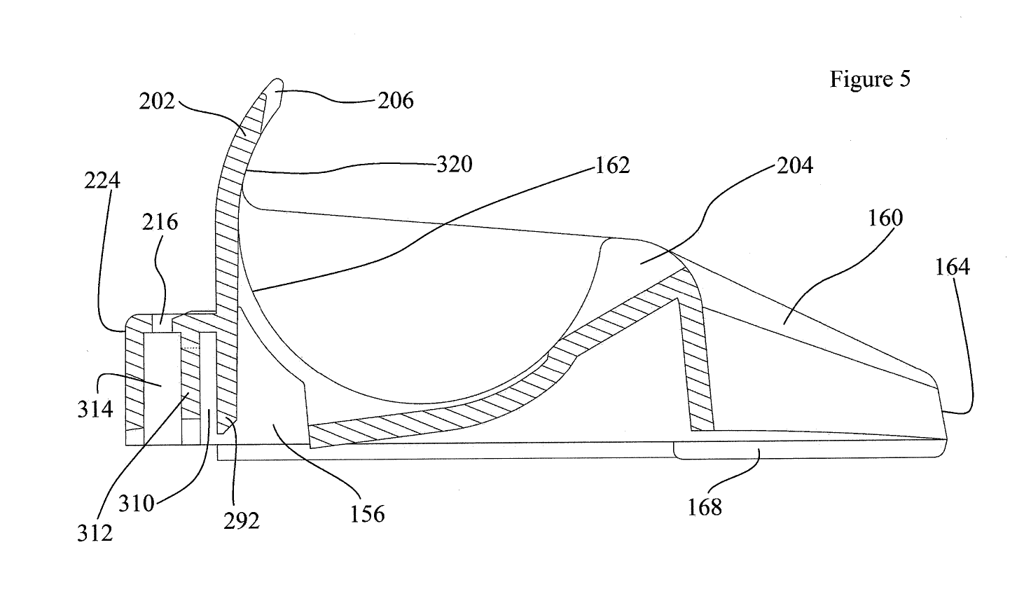

Body 160 of applicator head 102 is shown in cross sectional view in FIG. 5 without the blade 140 and/or the cam follower 230 mounted therein.

In particular FIG. 5 shows retaining wall 292, blade channel 310; which houses the vertical portion 144 of blade 140, channel wall 312 which together with rear wall 224 defines cam housing 314 for housing cam follower 230 therein as well as cam 148. It further shows selector slot 216 wherein selector 232 protrudes therethrough.

### IN USE

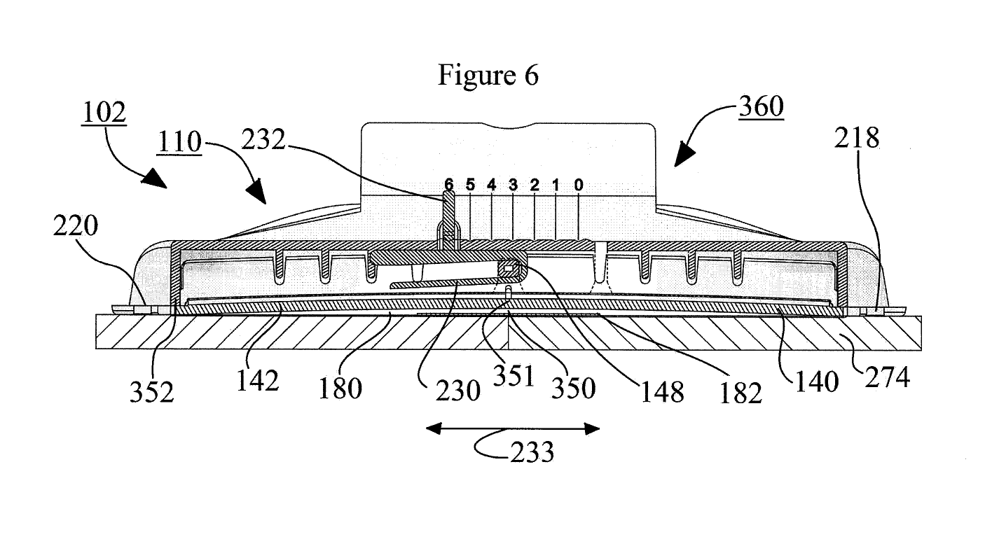

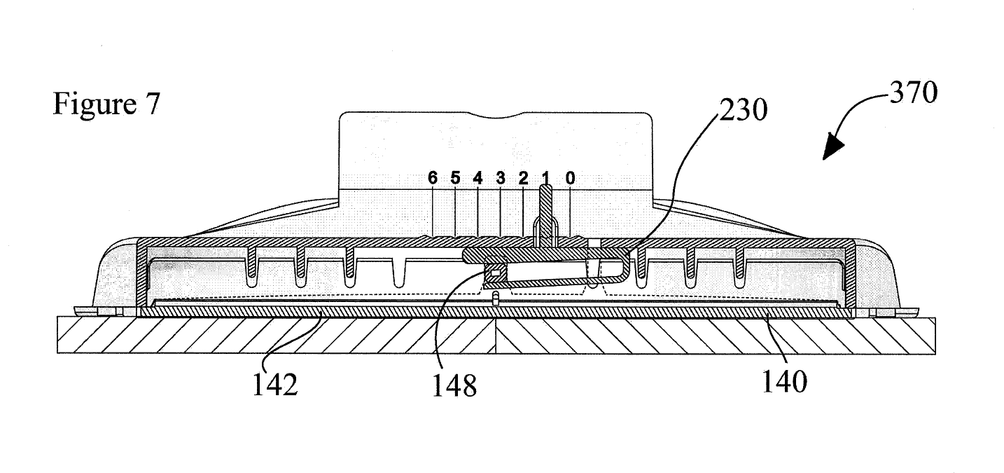

Referring now to FIGS. 6 and 7 the adjustment mechanism 110 is shown firstly in a highest cambered position 360 in FIG. 6 wherein selector 232 is indicated as position number 6 on scale 212. In this position cam follower 230 is urged in a lateral direction 233 to its rightmost position thereby lifting the central portion 351 via the cam 148 which is rigidly attached to blade 140 as cam 148 rides within cam follower 230.

When adjustment mechanism 110 is in the highest cambered position 360 show in FIG. 6 the crown center 350 is at its maximum namely the height of the horizontal portion 142 of blade 140 is at its maximum off of drywall 274 as shown in FIG. 6.

The centre of blade 140 can be urged upwardly as shown in FIG. 6 however both the left skid 170 and the right skid 172 of blade 140 are constrained from movement since they contact with left abutment 218 and right abutment 220 respectively. Further, positioning fingers 155 mate with corresponding vertical slots 154 to constrain lateral movement.

The ends of blade 140 are constrained from moving upwardly however the center portion where cam 148 is located is free to move upwardly thereby creating a crowned or curved horizontal portion 142 of blade 140.

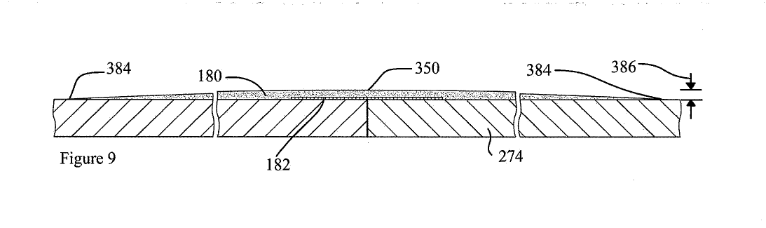

In this manner when compound 280 is forced under the horizontal portion 142 of blade 140 and out through exit slot 294 a crowned compound bead is created typically as shown in FIG. 9.

Referring now to FIG. 7 wherein adjustment mechanism 110 is shown in a low cambered position namely wherein selector 232 is urged to position numeral 1 on scale 212 which is almost the lowest camber position available.

When selector 232 is moved to 0 on scale 212 this would be the no cambered position in other words the horizontal portion 142 of blade 140 would be completely flat and have no camber whatsoever and would uniformly make contact with drywall 274.

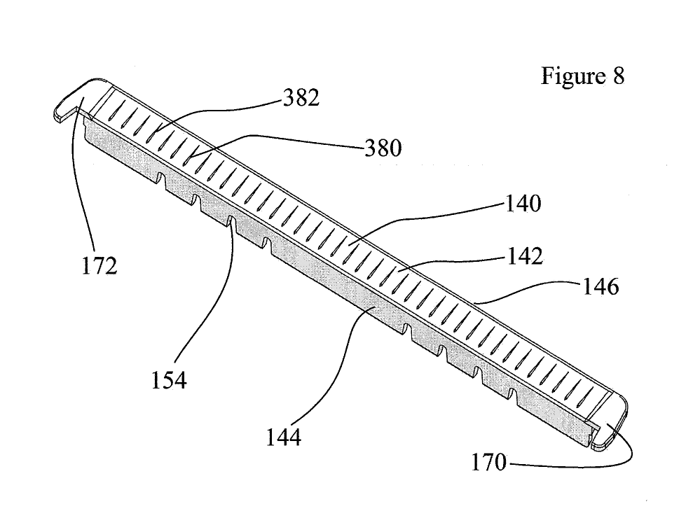

Referring now to FIG. 8 blade 140 is shown such that the bottom side 382 is visible. The bottom side 382 is on a slight incline 290 as compound 280 is urged out through and along the horizontal portion 142 of blade 140.

Blade 140 includes projections 380 which preferably are small longitudinally oriented protrusions which are spaced evenly along the transverse length of blade 140.

FIG. 9 shows the compound bead 180 having previously exited the applicator head 102.

The bead thickness 386 is shown as the distance between the crown center 350 and the drywall 274. The compound bead 180 is further shown having a convex profile with boundaries defined by the bead edge 384 and a vertex defined by the crown center 350.

### FURTHER EMBODIMENT

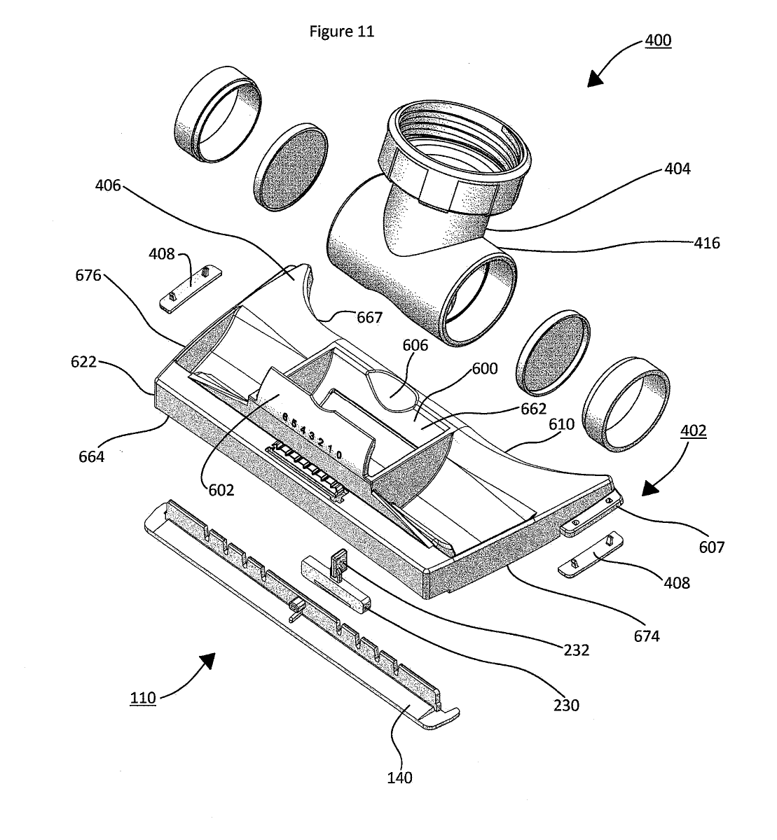

An alternate embodiment of the present concept is a compound applicator shown generally as 400 as shown in FIGS. 11.

Referring first to FIGS. 1 and 11, the major components of compound applicator 400 are as follows: applicator head 402 attached to an applicator reservoir 106 which in turns is attached to an applicator gun 108.

The major components of the applicator head 402 are as follows: pressure control connector 404, body 406, front skid 408, and adjustment mechanism 110.

Referring specifically to FIG. 11 which show further details of the body 406 of applicator head 402. The reader will note that the body 406 shown in FIG. 11 is similar to body 160, shown in FIGS. 1 to 10, with minor modifications relating to the removability of the skids; namely, the left skid 170 and right skid 172.

The body 406 defines a socket 662 wherein the pressure control connector 404 snugly fits therein. The body 406 further includes leading edge 664, trailing edge 667, and skid socket 607. A front skid 408 is releasably attached to each skid socket 607.

Socket 662 includes bearing surfaces 600 socket flange 602, connector relief 604 and flange relief 606. Transverse section 416 slideably and pivotly is received onto bearing surface 600 of socket 662. Socket flange 602 is resiliently flexible enough such that one is able to simple insert the transverse section 416 of pressure control connector 404 by manually urging transverse section 416 downwardly into socket 662 until the transverse section 416 snaps in place.

Referring now to body 406 of applicator head 402 it further includes a front portion 610 and a rear portion 622.

The reader will note the adjustment mechanism shown generally as 110 is unmodified in this alternate embodiment.

1. A compound applicator comprises;
a) an applicator head which includes a body for applying a bead of compound onto a surface, wherein the profile of the compound bead has a convex profile with a crown and bead thickness;
b) a means for controlling the crown and bead thickness of the convex profile with an adjustment mechanism;
c) wherein the adjustment mechanism includes a one piece L-shaped blade which includes a horizontal portion and a vertical portion and wherein the distal ends of the vertical portion and horizontal portion of the blade abut against the body, such that the horizontal and vertical portions of the blade can be resiliently flexed between a highest cambered position and a low camber position by vertically displacing a central portion of the blade.

2. The compound applicator claimed in claim 1 wherein the adjustment mechanism further includes a cam and a cam follower, such that urging the cam follower laterally in one direction lifts the central portion of the blade up to a the highest cambered position and urging the cam follower laterally in the opposite direction lowers the central portion of the blade down to a low camber position.

3. The compound applicator claimed in claim 2 wherein the cam follower is a linear inclined cam follower.

4. The compound applicator claimed in claim 2 wherein the adjustment mechanism further includes an upstanding selector connected to the cam follower for finger actuation of the cam follower in the lateral direction.

5. The compound applicator claimed in claim 2 wherein the vertical portion includes at least four spaced apart vertical slots and the body includes corresponding slideably engaging positioning fingers adapted to prevent lateral movement of the blade, and allow vertical portion to flex with horizontal portion.

6. The compound applicator claimed in claim 4 further including laterally spaced indents releasably engaging with the selector for indexing the cam follower to from the highest cambered position to the low camber position and to intermediate camber positions.

7. The compound applicator claimed in claim 1 wherein the distal ends of the horizontal portion includes left and right skids integrally part of the blade, the skids providing a smooth sliding area when the blade contacts the surface.

8. The compound applicator claimed in claim 1 wherein the blade left skid and right skid project beyond the left edge and right edge of the body respectively.

9. The compound applicator claimed in claim 1 wherein the horizontal portion including evenly laterally spaced projections along a bottom side, the projections are elongated along a longitudinal orientation and serve to create even flow across the bottom side of the horizontal portion.

10. The compound applicator claimed in claim 1 further including a pivoting connector for connecting a compound applicator reservoir to the body and channeling compound from the reservoir to the body, the connector includes a hollow longitudinal section attached to a hollow transverse section, the transverse section dimensioned to fit in a socket defined in the body, such that the connector pivoting between a down position and an up position.

11. The compound applicator claimed in claim 10 wherein the connector includes a cylindrically shaped transverse section dimensioned to fit in a partial cylindrically shaped socket such that the connector pivots about a pivot axis, however prevents rotation of the body about the longitudinal direction.

12. The compound applicator claimed in claim 11 wherein the longitudinal section includes a threaded collar inlet for connecting to the reservoir.

13. The compound applicator claimed in claim 2 wherein the body includes removable front skids located at the distal ends of a front portion of the body, the skids providing a smooth sliding area when the body contacts the surface.

14. The compound applicator claimed in claim 1 further includes an applicator gun for urging compound out of the applicator reservoir, through the body and out through a flow channel defined in the body for distributing compound along the length of the blade.

15. The compound applicator claimed in claim 9 further includes an applicator gun for urging compound out of the applicator reservoir, through the connector and body and out through a flow channel defined in the body for distributing compound along the length of the blade.
